(19) United States
(12) Patent Application Publication
(10) Pub. No.: US 2003/0217015 A1
(43) Pub. Date: Nov. 20, 2003

(54) Internet communication method and facility

(76) Inventor: Hugh Heathcote Gilbert, Dalham (GB)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/435,836

(22) Filed: May 12, 2003

(30) Foreign Application Priority Data
May 14, 2002 (GB) 0211033.6

(51) Int. Cl. H04K 1/00

(52) U.S. Cl. 705/76

(57) ABSTRACT

A method and facility for providing Internet communication between consumers and providers of products and services are provided. A secure location is provided for information retrievable by a particular consumer. The location is accessible for input of messages by providers, has an address, such as an e-mail address, and includes profile information about the particular consumer. Neither the address, nor the profile, identifies the consumer to the providers. The address of the location and the profile of the particular consumer is communicated to the provider thereby allowing consumers to obtain information from providers via the Internet in an anonymous manner.

### BACKGROUND TO THE INVENTION

This invention relates to a method and facility for providing an internet communications link between consumers and providers of products and services.

Consumers often do not wish to give out their names, addresses, and/or e-mail addresses on-line for fear of being badgered by the provider to whom this information is given and by other companies and even individuals. The subsequent bombardment of information may fill up their letter box or their e-mail box and make it very difficult to sort wanted information from unwanted “junk mail”. This reluctance may even prevent consumers from applying for information in which they are genuinely interested. If a name and address is given then it may be false, which generates worthless corrupting data.

On the other hand, consumers do want information about products, subjects etc. they are specifically interested in. Furthermore the type of information consumers want varies considerably, even within similar product categories, dependent upon their consumer profile.

### SUMMARY OF THE INVENTION

It is one object of the present invention to provide a method and facility allowing consumers to obtain information from providers via the internet in an anonymous manner. A further object is to allow payment for products or services via the internet either without the use of credit cards or the like and thus to improve the security of such transactions or without having to give a genuine address thus preserving anonymity.

The invention provides a method for providing an internet communications link between consumers and providers of products and services comprising providing a secure location for information retrievable by a particular consumer, the location being accessible for input of messages by providers, and the location having an address, e.g. an e-mail address, and a profile comprising information about the particular consumer, wherein neither the address nor the profile identifies the consumer to the providers; and communicating the address and the profile to providers.

In a particular embodiment, the profile is obtained by requiring the consumer to complete a questionnaire before allocating the secure location to the consumer. The profile may comprise information such as the date of birth, postcode, and/or gender of the consumer and may be input in the form of passwords used to access the secure location. Although providers do not know the real identity of the consumers, they are able to derive a considerable amount of demographic information about the consumers. Furthermore, the obtained profile derived from the compulsory questionnaire may be supplemented by information provided by the consumer on a voluntary questionnaire, or a space to list their likes and dislikes. Due to the anonymity afforded by the secure location, consumers may be more willing to impart personal information in the knowledge that by so doing this information will be made available to others who may as a consequence be able to deliver relevant information pertaining to the consumer's profile, to the secure location. Furthermore the information given by the consumer may be used to control the inflow of information in the form of filters to the secure location.

In an embodiment of the method, information about web sites or pages of a particular web site visited by the consumer is obtained from information stored on the user's computer and added to the consumer's profile. In the case of a web site displaying advertisements, the non-identifying addresses and profiles of consumers viewing a provider's advertisement may be communicated to that provider.

In this way, the invention provides a means for obtaining, and a repository for, targeted, wished for and appropriate information from advertisers and other sources on-line totally anonymously.

In an embodiment of the invention, the secure location is used for purchasing goods or services on-line without the need to give one's credit card details. In this case the method comprises communicating the identity and address of the consumer and funds from the consumer via an organiser of the secure location to a provider from whom the consumer wishes to purchase goods on-line. Payment from the consumer to the organiser may be by means of a deposit account

Whilst the address and consumer profile may be made generally available, so as to facilitate transferring information to the secure location, preferably the secure location is accessible only by the consumer to retrieve information therefrom. In a particular embodiment, the secure location comprises a first part accessible only by a provider specified by a consumer requesting information therefrom and a second part into which any provider may transfer unsolicited information. The first part may comprise means for distinguishing between solicited and unsolicited information and forwarding unsolicited information to the second part.

The invention also provides apparatus comprising a host computer providing an internet communications link between consumers and providers of products and services, the computer providing secure locations each for information retrievable by a particular consumer, the locations being accessible for input of messages by providers, and the locations having addresses, e.g. e-mail addresses, and profiles comprising information about the particular respective consumers, wherein neither the addresses nor the profiles identify the consumers to the providers.

### BRIEF DESCRIPTION OF THE DRAWINGS

Further objects and advantages of the invention will become apparent from a consideration of the following exemplary embodiments, in conjunction with accompanying drawings, in which:

FIG. 1 schematically shows a system according to the invention; and

FIGS. 2 and 3 shows embodiments of the invention allowing the online purchase of goods or services.

### DETAILED DESCRIPTION OF PARTICULAR EMBODIMENTS

The present invention provides a facility for the anonymous obtaining of information on products and services by consumers. A consumer obtains a secure location, referred to below as an “inBox”, for example via an organiser's web site, inputting a non-identifying user name and a password made up of easy-to remember profiling information such as gender, post code, age or the like. This profiling information may then be communicated, together with means for contacting the consumer via the secure location, to advertisers whose advertisements the consumer has viewed on the organiser's web site.

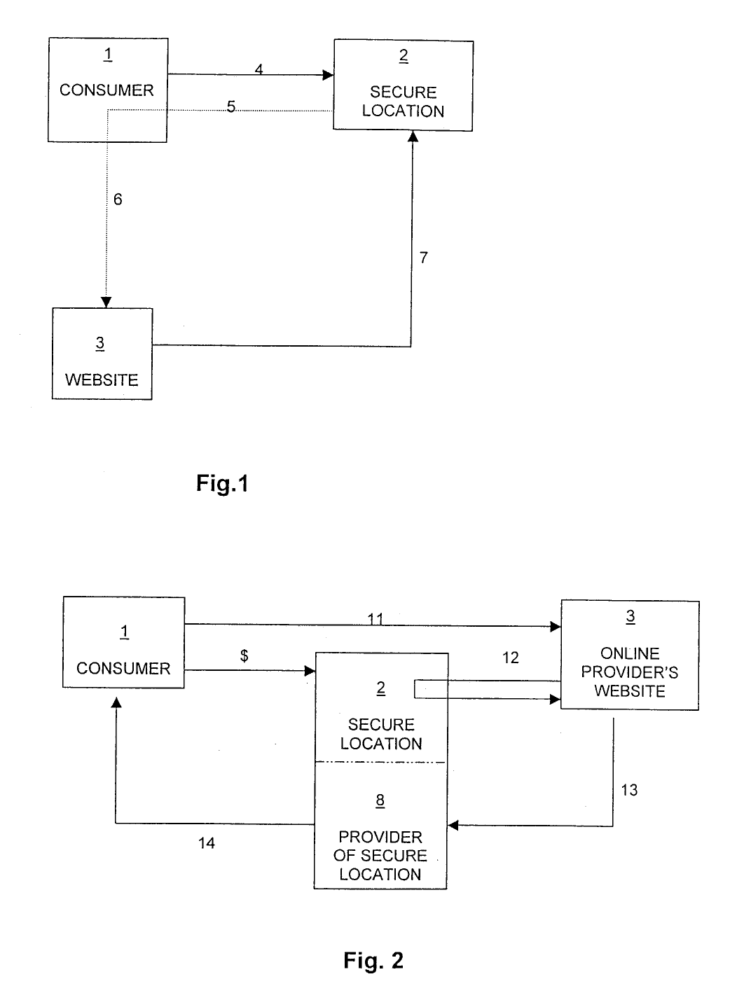

As shown in FIG. 1, a consumer 1 applies for an “inbox” 2 account by submitting 4 an invented username, together with passwords. An anonymous e-mail address is then issued 5 to the consumer which the consumer then uses to request information from a web site 3 The web site 3 sends the information 7 to the consumer's “inBox” account 2 for access by the consumer 1.

Each “inBox” consists of two parts—a public face and a private safe deposit box. The public face is a consumer profile of the owner of the “inBox”, input by the consumer, and available to everyone.

This data describes the owner of the “inBox” in all facets excepting the name and address of owner, or anything that allows readers to deduce this data. It is derived from a short questionnaire each “inBox” owner must complete before taking ownership. The “InBox” provider need not know the real identity of the “inBox” owner (with the exception of transaction boxes described below), so the details of the owner are totally anonymous.

The present invention is more advantageous than simply providing a second email address for use by consumers as a repository for all unwanted email or advertising information from suppliers. In particular, the profile means that a consumer will learn about products and services that are more relevant to him. It also means that advertisers can target particular groups, and lower the risk of bombardment. A smaller benefit is that the non-identifying address can never inadvertently be connected with the real user, as a fake email can. The consumer's profile may also be used to filter information inflow to the “inBox”.

The public face may include an internet pseudonym, and an e-mail address stemming from the “inBox”. It may also include a non-genuine letter mail address. Frequently on-line information providers require an address if a consumer cannot provide an address he may not have access to the information.

The private safe deposit box is only accessible to the owner by password and only the owner can access the contents. Outside sources can deposit items within the safe deposit box, as can the owner, however only the owner can access the safe deposit box.

The safe deposit box can be “swept clean” by the owner at the touch of a button and can be organised into subjects (allowing partial cleaning). It can be set up so as to categorise and organise any incoming mail into these subjects, or to group responses into supplier folders automatically. The subjects chosen could become part of the public face.

Items can be forwarded by the owner from the safe deposit box to the owner's email address and received e-mails can be replied directly to from within the “inBox”, however there is specifically no facility for sending out general e-mails from within the “inBox” to avoid spamming or other harassment.

There could be two levels of repository in the private safe deposit box:

the first level for users to use when they actively request info from suppliers

the second level for use by suppliers who want to send targeted junk advertising

On the first level there could be filtering, which may be derived from the consumer's profile, applied which only lets through information actively requested from suppliers. All other information sent to this address is automatically sent to the second level.

The second level takes in all information sent to the “inBox” but not actively requested. The second level can be “cleaned” separately from the first level.

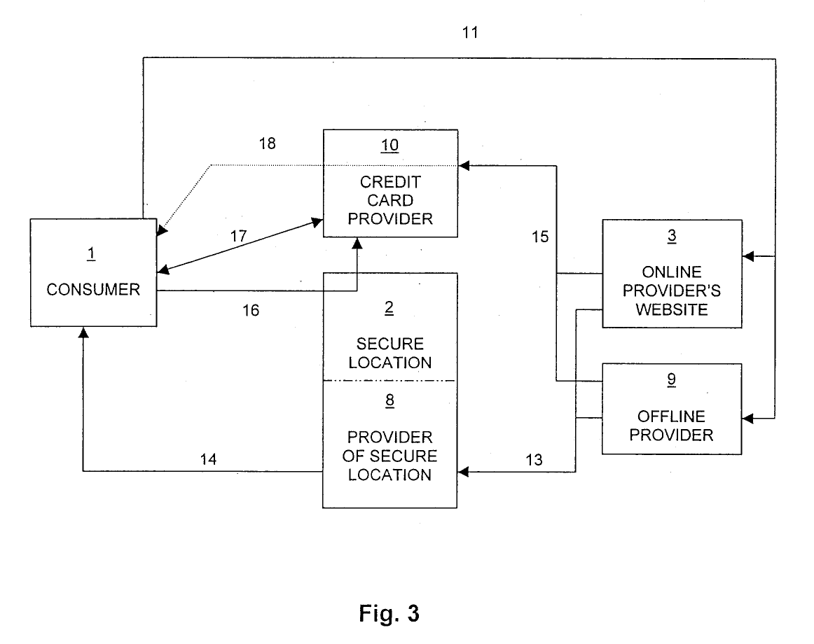

FIG. 2 shows a separate embodiment of the above called the “Transaction Box” which consumers may want to sign up for separately. A consumer 1 deposits money into his “inbox”/“Transaction Box” account 2 and is given a unique identifier identifying either a particular amount of money earmarked for a particular purchase or identifying the consumer's “inbox”/“Transaction Box” account. The consumer then purchases goods from an online provider 3 by submitting 11 this unique identifier together with a half-way house address which may or may not be the physical address of the “inbox” provider 8. The online provider 3 uses the unique identifier to check (12) with the consumer's “inbox”/“Transaction Box” account 2 that the funds are present and may or may not withdraw the funds at this time to pay for the purchase. The online provider 3 then delivers the purchased goods 13 to the halfway house 8, where the goods are relabelled with the consumers genuine address and delivered on 14 to the consumer 1.

The consumer's details are held confidentially by the “inBox” provider. The money is credited to the “Transaction Box” account and enables consumers to pay for items on-line using their “Transaction Box” accounts. When a consumer visits a participating web site he is given the option to pay for goods via his “Transaction Box”. If he opts for this option an automatic check is made by the participating web site that adequate funds reside in the “Transaction Box” and the appropriate funds are either reserved for this transaction or transferred to the participating web site in return for delivery of the goods. A number is allocated to this transaction. The goods can be delivered direct to the delivery address nominated by the consumer which may be to the “Transaction Box” provider's physical address. In which case the goods are delivered together with the identifying number, or an encrypted version of the identifying number to the “Transaction Box” provider, where the identifying number, which may be part of the address the consumer gives the web site delivering the goods, is read, which may be by bar code scanner or other means, and the consumer's correct address is identified from this number. The address label on the goods is then replaced with the consumer's correct address and the goods are dispatched onwards to the consumer without the deliverer of the goods ever learning the consumers correct address or credit card details. If the goods can be delivered on-line then they could be delivered to the consumer's “inBox”.

A further embodiment of this aspect is that the consumer can allocate exactly the funds required to purchase specific items within his “Transaction Box” and give this package of allocated funds an identifier that he then passes on to the provider of goods, so that the goods provider only has access to these specific funds in return for the requested goods.

A further embodiment of this aspect of the invention is to make an arrangement with a credit card provider whereby “inBox” owners and/or “Transaction Box” owners are issued with “inBox” credit cards that include the inBox owner's anonymous username and an anonymous address which may be a combination of the “inBox” provider's physical address and an identifying number further identifying the “inBox” owner anonymously.

As shown in FIG. 3, a consumer 1 applies for an “inBox” credit card account either via 16 the “inBox”/“Transaction Box” 2 or directly to a credit card provider 10. The credit card provider 10 issues 17 a credit card to the consumer 1 which has a Private address, which is the consumers address, and a Public address which is the address of the half-way house 8 including a unique anonymous identifier identifying the consumer. It may also include the consumer's “inBox” account name. The consumer then purchases goods from an online provider 3 or an offline provider 9 by submitting 11 this credit card with the Public address details on The online provider 3 or the off line provider 9 verifies the Public credit card details 15 with the credit card provider 10 and bills the credit card provider 10. The credit card provider 10 then bills the consumer 1 via his genuine address 18. The online provider 3 or the offline provider 9 then delivers the purchased goods 13 either to the Public address on the credit card which is the halfway house 8, or to an alternative address nominated by the consumer 1. If the goods are delivered to the half way house then the unique identifier within the address identifies the consumer to the half way house who then re-labels the goods with the consumers genuine Private address and delivers them on 14 to the consumer 1. The consumer 1 can use his “inBox” credit card as a normal credit card for any transaction, online or offline where he would normally use a credit card.

The credit card provider 10 holds two address for the consumer 1. One is a Private address which is his genuine address to which all bills are sent, the other is a Public address which is his anonymous inBox 2 address to which all goods are sent and all card verification is carried out with. Thus if a consumer 1 purchases goods either on or off-line using his inBox credit card then the details he gives to the provider of goods or services are his anonymous inBox name and anonymous inBox address. The card is verified against these Public name and address. The goods can then be delivered to any address the consumer nominates which may be to the anonymous inBox address. At the anonymous inBox address location the identifying number and the inBox name identify to the inBox provider the inBox owner's correct address and the goods are forwarded on to the consumer's genuine address. Furthermore if the consumer so wishes he may be able to instruct the inBox provider to deliver the goods at a certain time convenient to him. Thus the consumer has been able to purchase goods totally anonymously. If the anonymous inBox address is sent unsolicited “junk” mail as a consequence of using his inBox credit card then the inBox provider can filter this junk mail from genuine goods to be delivered to the inBox owner, thus protecting the inBox owner from physical junk mail.

A further use for the “inBox”, as it holds the owners preference and details, could be to search for items, information that the consumer is likely to be interested in and present it in an easily digestible format. One embodiment of this is that it could trawl the web looking for web sites, user groups etc. likely to interest the consumer. A further embodiment is that it could be used to find TV and radio programmes at the start of every week that the consumer is likely to be interested in. Once the information has been gathered the information could be tabulated so that the owner of the “inBox” merely has to access his/her “inBox” to find out which TV programmes are likely to appeal to him/her during the forthcoming week. These could be used to set their video recorder or interactive TV/video apparatus to suit.

The present invention thus provides a secure location having a non-identifying address usable by consumers to respond anonymously to web sites they are interested in. Consumers can display their preference and their profile publicly, but anonymously, allowing others to target them appropriately with information, without compromising their privacy. They can sort mail and clean it out easily, if required, clean it all out, without jeopardising their public e-mail. Consumers can use the fact that their locations hold data and preferences on them anonymously to find which TV, Radio etc; programmes will appeal to them and to organise these into a programme guide for a forthcoming period. Consumers can also use the profile provided by the invention to search for web sites and user groups that are likely to interest them.

Advertisers can buy lists of profiles much as they buy list of names. The apparent disadvantage is that they will not include names or addresses; the advantages are that the consumer profiles will give the advertiser much more accurate and valuable information about consumers than would normally be available from a named list, and the advertisers can contact consumers with less fear of irritating them. The consumer is more likely to give genuine information within his or her consumer profile because this information will be used to target him or her with propositions likely to be of interest.

Web site owners can offer a “click-through” service to sign up for a secure location at the point of registration as an alternative to visitors giving false information to their registration database. Site owners will not then know the name and address of the visitor but will know the consumer profile and have a contact address. Also many consumers do not progress through web sites because of the need to register being able to register anonymously will potentially convert more people into registered visitors. Where a web site owner recognises the e-mail address as a consumer using the present invention he can disregard the mail address information. He can use this to either admit or exclude the consumers.

The organiser, i.e. the operator of the invention, has a list of registered consumers with data on each. He has the consumer profile of each and traffic data. He can sell this data in lists to advertisers much as name lists are sold. The organiser will become by default an internet service provider (ISP) for mail with consequent advertising, shopping and other opportunities.

I claim:

1. A method for providing an internet communications link between consumers and providers of products and services comprising providing a secure location for information retrievable by a particular consumer, the location being accessible for input of messages by providers, and the location having an address and a profile comprising information about the particular consumer, wherein neither the address nor the profile identifies the consumer to the providers; and communicating the address and the profile to providers.

2. The method of claim 1, wherein the profile is obtained by requiring the consumer to complete a questionnaire before allocating the secure location to the consumer.

3. The method of claim 1, wherein the profile includes the date of birth of the consumer.

4. The method of claim 1, wherein the profile includes the zipcode of the consumer.

5. The method of claim 1, wherein the profile includes the gender of the consumer.

6. The method of claim 1, comprising inputting information forming part of the profile in the form of at least one password to access the secure location.

7. The method of claim 1, wherein the profile includes the consumer's preferences.

8. The method of claim 1, wherein the profile is used to control the inflow of information by means of filters to the secure location.

9. The method of claim 1, wherein information about web sites or pages of a particular web site visited by the consumer is obtained from information stored on the user's computer and added to the consumer's profile.

10. The method of claim 1, wherein the non-identifying addresses and profiles of consumers viewing a provider's advertisement on a web site are communicated to that provider.

11. The method of claim 1, wherein the secure location is accessible only by the consumer to retrieve information therefrom.

12. The method of claim 1, wherein the secure location comprises a first part accessible only by a provider specified by a consumer requesting information therefrom and a second part into which any provider may transfer unsolicited information.

13. The method of claim 12, wherein the first part comprises means for distinguishing between solicited and unsolicited information and forwarding unsolicited information to the second part.

14. A method of purchasing goods or services anonymously on-line, comprising providing a secure location for information retrievable by a particular consumer, the location having an address and a profile comprising information about the particular consumer, wherein neither the address nor the profile identifies the consumer to the providers; and communicating the address and the profile and funds from the consumer via an organiser of the secure location to a provider from whom the consumer wishes to purchase goods on-line.

15. The method of claim 14, comprising obtaining the funds from the consumer to the organiser by means of a deposit account

16. The method of claim 14, comprising communicating the funds to the provider by means of a credit card identifying only the organiser of the secure location and not the consumer.

17. Apparatus comprising a host computer providing an internet communications link between consumers and providers of products and services, the computer providing secure locations each for information retrievable by a particular consumer, the locations being accessible for input of messages by providers, and the locations having e-mail addresses, and profiles comprising information about the particular respective consumers, wherein neither the addresses nor the profiles identify the consumers to the providers.
